(19) United States
(12) Patent Application Publication
(10) Pub. No.: US 2025/0365807 A1
(43) Pub. Date: Nov. 27, 2025

(54) SYSTEMS AND METHODS FOR CORE NETWORK BASED IDLE QUALITY OF EXPERIENCE CONFIGURATION RETRIEVE

(71) Applicant: ZTE CORPORATION, Shenzhen (CN)

(72) Inventors: Yansheng LIU, Shenzhen (CN); Dapeng LI, Shenzhen (CN); Yin GAO, Shenzhen (CN); Man ZHANG, Shenzhen (CN); Zhuang LIU, Shenzhen (CN)

(73) Assignee: ZTE CORPORATION, Shenzhen (CN)

(21) Appl. No.: 19/296,548

(22) Filed: Aug. 11, 2025

Related U.S. Application Data
(63) Continuation of application No. PCT/CN2023/076857, filed on Feb. 17, 2023.

(51) Int. Cl. H04W 76/27; H04L 43/0805

(52) U.S. Cl. CPC H04W 76/27; H04L 43/0805

(57) ABSTRACT

Presented are systems and methods for core network (CN) based IDLE Quality of Experience (QoE) configuration retrieve. A wireless communication entity may store Quality of Experience (QoE)-related information, in response to or prior to a wireless communication device switching to a Radio Resource Control Idle (RRC_IDLE) state.

### CROSS-REFERENCE TO RELATED APPLICATION

This application claims the benefit of priority under 35 U.S.C. § 120 as a continuation of PCT Patent Application No. PCT/CN2023/076857, filed on Feb. 17, 2023, the disclosure of which is incorporated herein by reference in its entirety.

### TECHNICAL FIELD

The disclosure relates generally to wireless communications, including but not limited to systems and methods for core network (CN) based IDLE Quality of Experience (QoE) configuration retrieve.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication entity (e.g., a core network (CN)) may store Quality of Experience (QoE)-related information, in response to or prior to a wireless communication device (e.g., a UE) switching to a Radio Resource Control Idle (RRC_IDLE) state. The stored QoE-related information may include only a QoE reference identification of a QoE configuration and an RAN Visible QoE (RVQoE) configuration received from a wireless communication node.

In some embodiments, the wireless communication entity may determine to retrieve the QoE-related information. The wireless communication entity may request the QoE-related information from an Operations, Administration and Maintenance (OAM) entity. The QoE configuration can be associated with the wireless communication device and one or more other wireless communication devices. The QoE-related information may comprise a whole of a QoE configuration. The whole of the QoE configuration may comprise at least one of: a QoE reference identification; a service type; an area scope; an MCE IP address; a QoE configuration container; MDT alignment info; an RAN visible configuration; an RRC level identification; UE information associated with the wireless communication device; or an RAN identification associated with the wireless communication node.

In some embodiments, the wireless communication entity may send the QoE-related information to a wireless communication node, in response to identifying that the wireless communication node or the wireless communication device is to retrieve the QoE-related information. The QoE configuration can be associated with the wireless communication device and one or more other wireless communication devices.

In some embodiments, the QoE-related information may comprise an identification (e.g., a UE ID) of the wireless communication device and a list including a plurality of QoE configurations. The list may comprise a whole of at least one of the QoE configurations which has been configured for the wireless communication device. The QoE-related information may comprise an identification (e.g., a UE ID) of the wireless communication device and a list including a plurality of QoE configurations. The list may comprise at least one of a QoE reference identification of QoE configuration or RAN Visible QoE (RVQoE) configuration which has been configured for the wireless communication device.

In some embodiments, the wireless communication entity may send a first message comprising an indicator for the stored QoE-related information to a wireless communication node. The indicator for the stored QoE-related information may indicate that a CN has stored the QoE configuration. The wireless communication entity may receive a second message from the wireless communication node. The first message and the second message can be each a Next Generation Application Protocol (NGAP) message. The second message may comprise at least one of: a QoE reference identification; a service type; an area scope; an MCE IP address; a QoE configuration container; MDT alignment info; an RAN visible configuration; an RRC level identification; UE information associated with the wireless communication device; or an RAN identification associated with the wireless communication node.

In some embodiments, prior to the wireless communication device switching to the RRC_IDLE state, further comprising: receiving, by the wireless communication entity from a wireless communication node, a message comprising the QoE-related information. The message can be a Next Generation Application Protocol (NGAP) message. The message may further comprise at least one of: a QoE configuration; a QoE reference identification; a service type; an area scope; an MCE IP address; a QoE measurement status; a QoE configuration container; MDT alignment info; an RAN visible configuration; an RRC level identification; NW slicing information; or an RAN identification associated with the wireless communication node.

In some embodiments, the wireless communication entity may receive a first message from a wireless communication node. The first message may comprise at least one of: UE information associated with the wireless communication device or the stored QoE-related information. The wireless communication entity may send a second message acknowledging the first message to the wireless communication node. The first message and the second message can be each a Next Generation Application Protocol (NGAP) message. The QoE-related information can be configured to indicate that a QoE configuration should be released. The UE information can be configured to indicate that the wireless communication device is associated with the to-be released QoE configuration. The UE information may indicate only the wireless communication device. The QoE configuration may indicate a list of QoE reference identifications. In some embodiments, the UE information may indicate a list of UE identifications. The QoE configuration may indicate a list of QoE reference identifications.

In some embodiments, the wireless communication entity may receive a message comprising update to the QoE-related information from a wireless communication node. The message can be a Next Generation Application Protocol (NGAP) message. In response to the wireless communication device accessing a network of the wireless communication entity, further comprising: sending, by the wireless communication entity to a wireless communication node, a message comprising the QoE-related information. The message can be a Next Generation Application Protocol (NGAP) message.

In some embodiments, the message may further comprise at least one of: an indicator for the QoE-related information; a QoE reference identification; a service type; an area scope; an MCE IP address; a QoE measurement status; a QoE configuration container; MDT alignment info; an RAN visible configuration; an RRC level identification; NW slicing information; or an RAN identification associated with the wireless communication node.

In some embodiments, in response to a wireless communication node receiving a first message from the wireless communication device, the first message may comprise at least one of an identification of the wireless communication device or an indicator for the stored QoE-related information. The wireless communication entity may receive a second message comprising the indicator for the stored QoE-related information from the wireless communication node. The wireless communication entity send a third message comprising acknowledging the second message to the wireless communication node. The second message and the third message can be each a Next Generation Application Protocol (NGAP) message. The third message further may comprise at least one of: the indicator for the QoE-related information; a QoE reference identification; a service type; an area scope; an MCE IP address; a QoE measurement status; a QoE configuration container; MDT alignment info; an RAN visible configuration; an RRC level identification; NW slicing information; or an RAN identification associated with the wireless communication node.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a sequence diagram for next generation application protocol (NGAP) enhancement, in accordance with some embodiments of the present disclosure;

FIG. 4 illustrates a sequence diagram for uploading Quality of Experience (QoE) configuration, in accordance with some embodiments of the present disclosure;

FIG. 5 illustrates a sequence diagram for next generation application protocol (NGAP) enhancement, in accordance with some embodiments of the present disclosure;

FIG. 6 illustrates a sequence diagram for Xn application protocol (XnAP) enhancement, in accordance with some embodiments of the present disclosure;

FIG. 7 illustrates a sequence diagram for core network (CN) based IDLE Quality of Experience (QoE) configuration retrieve, in accordance with some embodiments of the present disclosure;

FIG. 8 illustrates a sequence diagram for core network (CN) based IDLE Quality of Experience (QoE) configuration retrieve, in accordance with some embodiments of the present disclosure; and

FIG. 9 illustrates a flow diagram for core network (CN) based IDLE Quality of Experience (QoE) configuration retrieve, in accordance with an embodiment of the present disclosure.

### DETAILED DESCRIPTION

### 1. Mobile Communication Technology and Environment

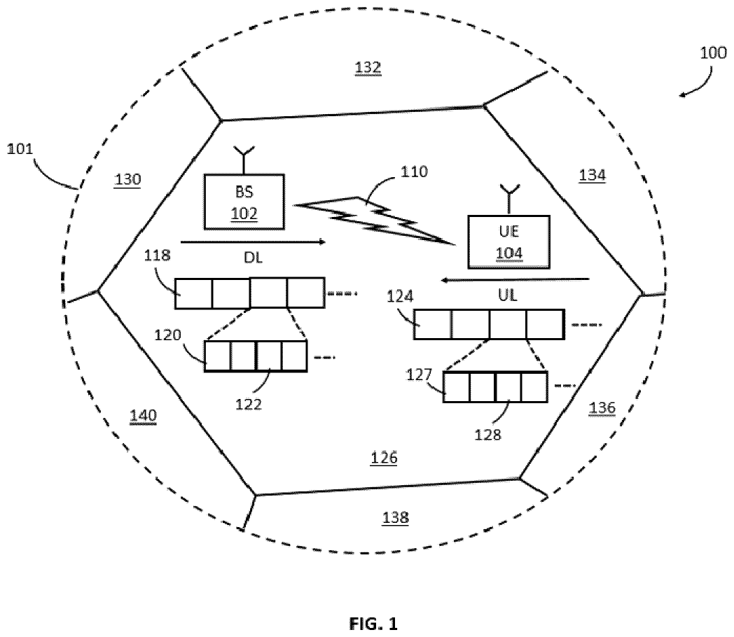

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

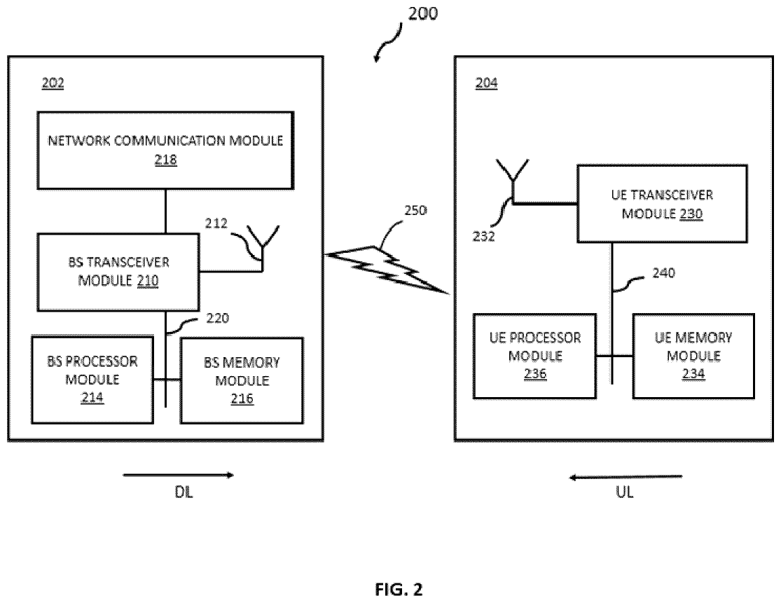

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Core Network (CN) based IDLE Quality of Experience (QoE) Configuration Retrieve

An INACTIVE/IDLE QoE can be supported. Based on current mechanism, a QoE can activate and can collect data when UE is in a RRC_CONNECTED state. With supporting for a new QoE service type (e.g., multicast and broadcast services (MBS)), a QoE can be needed to be performed in any RRC state in some cases. In some embodiments, a new kind of QoE (e.g., logged QoE) which can perform in non-CONNECTED state in some cases can be introduced. The logged QoE configuration and reporting is discussed below.

In this disclosure, a CN-based method can let a RAN node and/or a UE to retrieve previously configured IDLE QoE configurations when UE switches from RRC_IDLE to RRC_CONNECTED. For example, a CN can store a configured IDLE QoE configuration at the CN side when UE is in RRC_IDLE. When the UE re-accesses the network, the CN can re-send the stored IDLE QoE configuration to a RAN node and/or a UE for configuration retrieve.

A new radio (NR) Quality of Experience (QoE) which has been introduced in Release 17 can only perform QoE measurements when UE is in RRC_CONNECTED. A network (NW) may configure the QoE for a specific application to a UE when the UE is in RRC_CONNECTED. When the UE starts an application, the QoE can be activated and can start to measure QoE data. A QoE function which can be performed when a UE is in RRC_IDLE can be introduced.

### Implementation Example 1: A CN Can Store an IDLE QoE Configuration when a UE is in RRC_IDLE

An IDLE QoE may indicate/mean that a QoE-related measurement can be performed when a UE is in a radio resource control idle (RRC_IDLE) (e.g., CM_IDLE) state. A core network (CN) may have a capability to store the IDLE QoE (e.g., both management based IDLE QoE and signaling based IDLE QoE) information when the UE is in a RRC_IDLE (e.g., CM_IDLE) state.

For management based IDLE QoE, the CN can receive a QoE-related configuration via either a RAN node side or an operations, administration and maintenance (OAM) side. For signaling based IDLE QoE, the CN can receive the QoE-related configuration via an OAM. Considering that the RAN visible QoE (e.g., an RAN Visible QoE (RVQoE)) can be configured by a RAN node, the RVQoE configuration may be sent from the RAN node to the CN for storing after the RVQoE configuration is configured to the UE.

In some embodiments, there can be four alternatives for a CN to store the configured IDLE QoE configuration:
(1) A CN may only store a QoE reference ID of one QoE configuration and its RVQoE configuration received from a RAN node side. When the CN needs to retrieve the QoE configuration, the CN can send a request message to an OAM. The OAM may send the QoE configuration to the CN.
(2) A CN may store a whole QoE configuration. When a UE or a RAN node retrieves the QoE configuration, the CN can directly send the stored QoE configuration to a RAN node.

For each store IDLE QoE at CN side, a list of UEs which has been configured to this IDLE QoE measurement can be linked. The structure of the relationship can be shown as Table 1.

TABLE 1

| CN stored QoE configuration | UE info |
|---|---|
| Whole QoE configuration | A list of UE info |
| . . . | . . . |
| QoE reference ID and (optional) RVQoE | A list of UE info |
| configuration | |

(3) A CN may store a UE ID and a list of configured IDLE QoE configuration(s). The list may contain/include at least one of a whole IDLE QoE configuration which has been configured to the UE with this UE ID.
(4) A CN may store a UE ID and a list of configured IDLE QoE configuration(s). The list may contain/include at least one of the QoE reference ID and optional RVQoE configuration of the QoE configuration which has been configured to the UE with this UE ID.

TABLE 2

| UE info | CN stored QoE configuration |
|---|---|
| UE ID | Whole QoE configuration(s) which has been |
| | configured to this UE |
| . . . | . . . |
| UE ID | QoE reference ID(s) and (optional) RVQoE |
| | configuration |

### Implementation Example 2: NGAP Enhancement on IDLE QoE Configuration Uploading

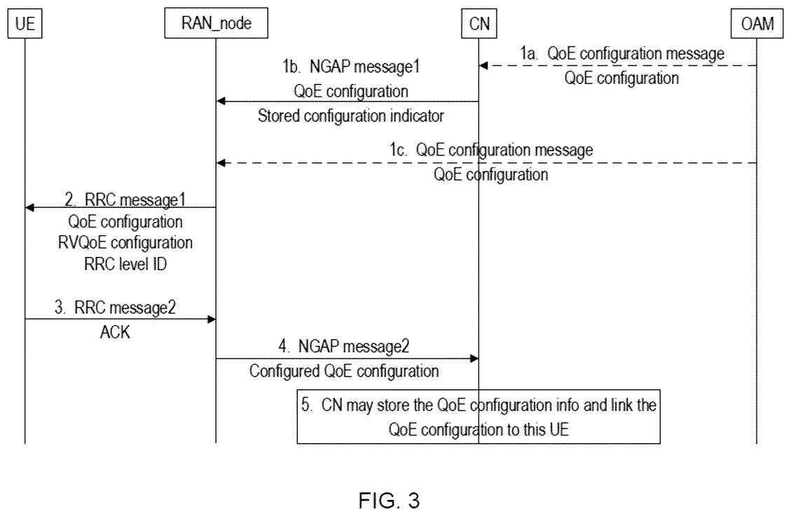

FIG. 3 illustrates a sequence diagram for next generation application protocol (NGAP) enhancement, in accordance with some embodiments of the present disclosure.

In step 1a, an OAM may configure a signaling based QoE to a CN.

In step 1b: a CN may receive the QoE configuration. The CN may send a NGAP message 1 to the RAN node. At least one of the following information can be included in this message: a list of the following information: one QoE configuration, and a stored configuration indicator for this QoE configuration. The stored configuration indicator can be used to indicate whether this QoE configuration has been stored at the CN side. If RAN node receives QoE configuration and the indicator, the RAN node may be notified that the RAN defined QoE configuration can be uploaded to the CN. If the RAN node only receives the QoE configuration, the RAN node may upload the whole configured QoE configuration and the RAN defined QoE configuration to the CN.

In step 1c, the OAM may directly configure the management based QoE to the RAN node.

In some embodiments, the OAM in step 1a and step 1c may not the same one. The transmission messages from the OAM to other entities (e.g. CN, RAN node) may not be a standard message.

In steps 2 and 3, RAN node may configure the QoE configuration to a UE via RRC procedure. The RAN defined configuration (e.g. RAN visible QoE, RRC level ID) can be also forwarded to the UE in this procedure.

In step 4, the RAN node may send a NGAP message (e.g. NGAP message 2) to the CN and may send the configured QoE information to the CN. At least one of the following information can be included in this message: a QoE reference identification; a service type; an area scope; an multi-cell/multicast coordination entity (MCE) IP address; a QoE configuration container; a QoE measurement status; NW slicing info; minimization of drive tests (MDT) alignment info; an RAN visible configuration; an RRC level identification; UE information associated with the wireless communication device; or an RAN identification associated with the wireless communication node. The QoE reference identification can be defined by the OAM and can be used to identify a QoE configuration. The service type may indicate the service type of this QoE measurement. The area scope can be a working area of this QoE session. This QoE measurement can only be triggered if the UE is in this area. The area scope may be a cell ID list, a tracking area (TA) list, a public land mobile network (PLMN) list or a tracking area identity (TAI) list. The MCE IP address can be an IP address of the entity receiving the QoE measurement report. The QoE measurement status may indicate whether the QoE measurement state (e.g., ongoing, or not start). The QoE configuration container may include an application layer measurement configuration. The NW slicing info may indicate which NW slice the QoE can measure. The MDT alignment info can be used for NW to perform the MDT and QoE alignment function. The MDT ID(s) may be included here. The RAN node may determine and may configure the RAN visible QoE configuration to the UE. The RRC level ID can be defined by the RAN node and can be used to distinguish/mark QoE sessions at the RAN side. If a message is a UE associated message, the UE info can be an access and mobility management function (AMF) UE NGAP ID IE and/or RAN UE NGAP ID IE. If this message is a non-UE associated message, the UE info can be a group of UE ID which is used to identify the UE that can be configured this QoE configuration. The RAN identification associated with the wireless communication node can be used to identify the NG-RAN node. If this message is a UE associated message, this ID may not be needed. If this message is a non-UE associated message, this ID may be needed.

In some embodiments, step 4 may be triggered before, during, or after steps 2 and 3. The info in step 4 may not be always transmitted. In some embodiments, only some of the above info can be be forwarded to CN. In certain embodiments, all mentioned info can be necessary to be transmitted to the CN.

A transmission sequence of the signaling based QoE can be OAM=>CN=>RAN node=>UE. Hence, when the CN receives the signaling based QoE configuration from the OAM, the CN may store the configuration and may send the configuration to the RAN node. In this situation, the RAN node may only transmit a RAN defined QoE configuration (e.g. RVQoE configuration, RRC level ID) to the CN.

A transmission sequence of the management based QoE can be OAM=>RAN node=>UE. Hence, when the RAN node receives the management based QoE configuration from the OAM, the RAN may transmit the whole configuration of this QoE measurement to the CN. In addition, if the OAM can directly transmit the management based QoE to the CN for IDLE QoE, the RAN node may only transmit the RAN defined QoE configuration (e.g. RVQoE config, RRC level ID) to the CN.

In step 5, the CN may store the received QoE configuration information.

### Implementation Example 3: A RAN May Upload IDLE QoE Configuration before Releasing a UE

In implementation example 2, a RAN may upload all configured QoE configurations (the configuration may be whole configuration or partial) to a CN after a RAN sends QoE configurations to a UE. The configuration can depend on CN behavior in previous steps. In other words, whenever the IDLE QoE configuration is configured to a UE, a CN may know the configured QoE configurations.

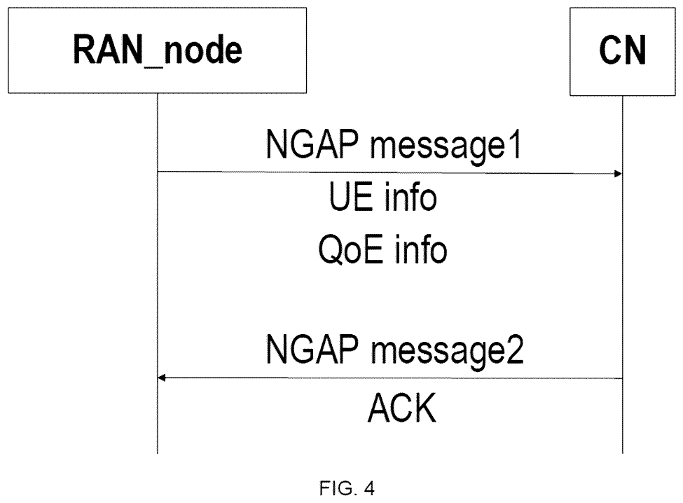

FIG. 4 illustrates a sequence diagram for uploading Quality of Experience (QoE) configuration, in accordance with some embodiments of the present disclosure.

In this implementation example, a RAN node may only upload a configured IDLE QoE configuration before a UE switches to a RRC_IDLE state. Before the RAN node completes a RRC release procedure, the RAN node may send a NGAP message1 to a CN. At least one of following info can be contained in this message: UE info; a RAN node ID; or a configured QoE configuration. The UE info can be used to identify a UE. The RAN node ID can be used to identify a NG-RAN node. The configured QoE configuration can be a list of configured QoE configurations which is still valid and has been configured to the UE. For each configured QoE configuration, at least one of the following info can be included: a QoE reference ID; a service type; an area scope; a MCE IP address; a QoE measurement status; a QoE configuration container; NW slicing info; MDT alignment info; a RAN visible configuration; or a RRC level ID. The QoE reference ID can be defined by an OAM and can be used to identify a QoE configuration. The service type may indicate a service type of this QoE measurement. The area scope can be a working area of the QoE session. The QoE measurement can only be triggered if the UE is in this area. The area scope may be a cell ID list, a TA list, a PLMN list, or a TAI list. The MCE IP address can be an IP address of the entity receiving the QoE measurement report. The QoE measurement status may indicate whether the QoE measurement state (e.g. ongoing, not start). The QoE configuration container may include a application layer measurement configuration. The NW slicing info may indicate which NW slice the QoE can measure. The MDT alignment info can be used for a NW to perform the MDT and QoE alignment function. The MDT ID(s) can be added here. The RAN node may determine and may configure the RAN visible QoE configuration to the UE. The RRC level ID can be defined by the RAN node and can be used to distinguish/mark QoE sessions at the RAN side.

When the CN receives NGAP message 1, the CN may store the received info and may reply the ACK info.

### Implementation Example 4: NGAP Enhancement on IDLE QoE Configuration Releasing

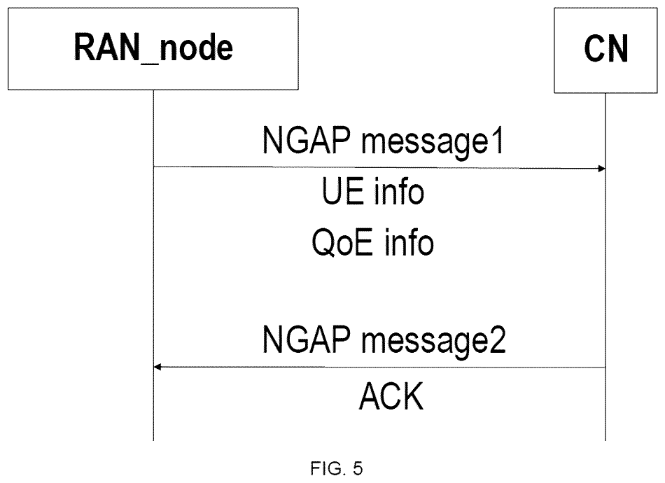

FIG. 5 illustrates a sequence diagram for next generation application protocol (NGAP) enhancement, in accordance with some embodiments of the present disclosure.

This procedure can be used for a RAN node to release a stored QoE configuration at a CN side. The RAN node may send NGAP message 1 to a CN. At least one of the following information can be contained in this message: UE-related information or QoE-related information. The UE info may indicate a QoE configuration of which UE can be released. The QoE info may indicate which QoE configuration can be released.

After the CN receives the NGAP message 1, the CN may release the QoE configuration of the UE. In some embodiments, a structure of the UE info and QoE info may be various.

If the NGAP message is a UE associated message, the UE info can be a defined IE which can identify one relevant UE in this procedure. The QoE info can be a list of QoE reference ID(s).

If the NGAP message is a non-UE associated message, the UE info can be a list of UE info and QoE info table. For each related QoE, a QoE reference ID can be provided. A list of UE ID(s) can be used to identify the UE which has been configured the QoE with the reference ID. Table 3 illustrates the QoE info and the UE info relationship.

TABLE 3

| CN stored QoE configuration | UE info |
|---|---|
| QoE reference ID | A list of UE ID |
| . . . | . . . |
| QoE reference ID | A list of UE ID |

Besides this procedure, a timer or a certain time may be used at a CN side for the configured QoE configuration. After the timer expires or a certain period, the CN may trigger a QoE configuration release procedure automatically.

### Implementation Example 5: A NGAP Enhancement RAN Node May Update QoE Configuration

As explained in implementation example 2, parts of the QoE configuration (e.g., RVQoE or RRC level ID) can be determined and can be configured by the UE's serving RAN node. Hence, if a RAN node decides to modify this part of QoE configuration, the RAN node can send the updated QoE configuration to the CN.

The NGAP message used in step 4, implementation example 2 can also be used for a RAN node to transmit any updates of the configured QoE configuration.

### Implementation Example 6: XnAP Enhancement Node 1 May Send IDLE QoE Configuration Status to Node 2

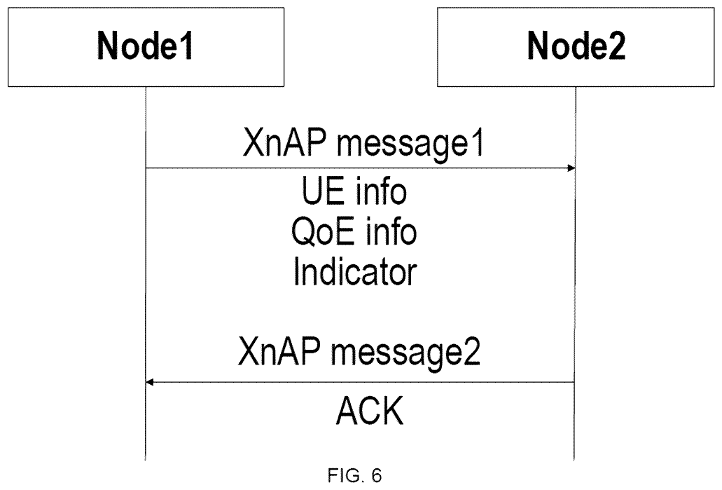

FIG. 6 illustrates a sequence diagram for Xn application protocol (XnAP) enhancement, in accordance with some embodiments of the present disclosure.

This procedure can be used during UE handover scenario. Node1 can be a source node and Node 2 can be a target node. The Node 1 may send XnAP message 1 to the Node2. For each configured IDLE QoE configuration(s) in this message, an indicator can be used to mark either of these two meanings: this QoE configuration has been transmitted and stored at the CN side; or this QoE configuration has not been transmitted and stored at the CN side.

The UE info can be used to mark which UE is related to this procedure. The QoE info may include multiple or one IDLE QoE configuration(s) which has been configured to this UE.

When Node 2 receives the XnAP message1, the Node 2 can reply XnAP message 2 as an ACK message.

In some embodiments, this procedure can also be used in a DC scenario. In such case, if Node 1 is MN, Node 2 can be SN. If Node 1 is SN, Node 2 can be MN.

Two meanings of the indicator shown in this implementation example are alternatives. In a final protocol, the indicator may only have one meaning: either mark the untransmitted QoE or mark the transmitted QoE.

### Implementation Example 7: A CN May Actively Detect IDLE QoE Configuration Retrieve

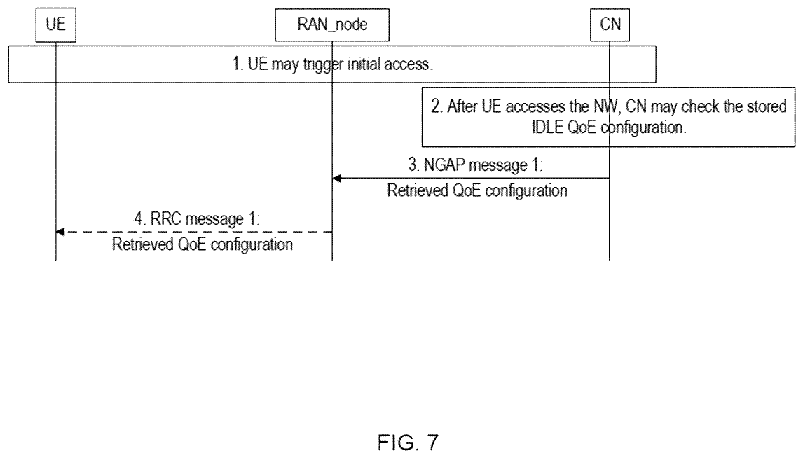

FIG. 7 illustrates a sequence diagram for core network (CN) based IDLE Quality of Experience (QoE) configuration retrieve, in accordance with some embodiments of the present disclosure. A UE can be in RRC_IDLE and may trigger an initial access procedure.

In step 1, a UE may perform a normal initial access procedure.

In step 2, when a CN receives the UE info, the CN may actively check/detect a stored QoE configuration table (e.g., list, container). The CN may find/detect the UE info in the table.

In step 3, for each QoE configuration which is marked by the UE info, the CN may send retrieved QoE configuration to a RAN node. At least one of the following info can be included in the NGAP message: a QoE reference ID, a service type, an area scope, a MCE IP address, a QoE measurement status, a QoE configuration container, NW slicing info, MDT alignment info, RAN visible configuration, a RRC level ID, a RAN node ID, a retrieved QoE configuration indicator, a defined QoE configuration, or a retrieved QoE configuration indicator. The QoE reference ID can be defined by an OAM and can be used to identify a QoE configuration. The service type may indicate a service type of the QoE measurement. The area scope can be a working area of the QoE session. This QoE measurement can only be triggered if the UE is in this area. The area scope may be a cell ID list, a TA list, a PLMN list, or a TAI list. The MCE IP address can be an IP address of the entity receiving the QoE measurement report. The QoE measurement status may indicate whether the QoE measurement state (e.g. ongoing, not start). The QoE configuration container may include an application layer measurement configuration. The NW slicing info may indicate which NW slice the QoE can measure. The MDT alignment info can be used for a NW to perform the MDT and the QoE alignment function. The MDT ID(s) can be added here. The RAN node may determine and may configure the RAN visible QoE configuration to the UE. The RRC level ID can be defined by the RAN node and can be used to distinguish/mark QoE sessions at the RAN side. The UE info can be an AMF UE NGAP ID IE and/or a RAN UE NGAP ID IE. The RAN node ID can be used to identify the last serving NG-RAN node before the UE enters a RRC_IDLE state. The retrieved QoE configuration indicator can be used to indicate that the QoE configuration has been configured to the UE. The information contained here can be for configuration retrieve. The NGAP message may be a response message.

In step 4 (optional), the RAN node may forward the received QoE configuration to the UE. For each configured IDLE QoE configuration, at least one of the following information can be include in the RRC message: a defined QoE configuration or retrieved QoE configuration indicator. The defined QoE configuration may re-use the defined QoE configuration format. The retrieved QoE configuration indicator can be used to indicate that the QoE configuration has been configured to the UE. The information contained here can be for configuration retrieve.

### Implementation Example 8: Retrieve Configured QE with Indicator

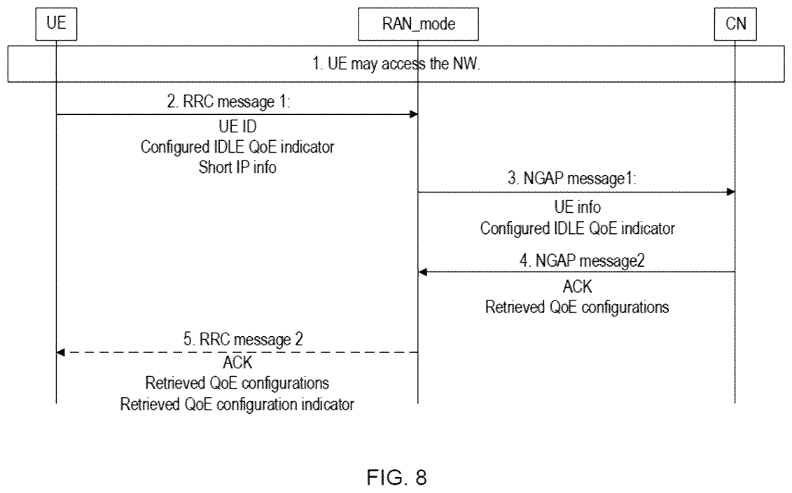

FIG. 8 illustrates a sequence diagram for core network (CN) based IDLE Quality of Experience (QoE) configuration retrieve, in accordance with some embodiments of the present disclosure. A UE can be in a RRC_IDLE state and may trigger an initial access procedure.

In step 1, a UE may access a NW.

In step 2, the UE may send a RRC message to a RAN node for QoE configuration retrieve. At least one of the following information can be included in the message: a UE ID, a configured IDLE QoE indicator, or short IP info. The UE ID may indicate a related UE (e.g., the UE). The configured IDLE QoE indicator can be used to illustrate the UE has been configured QoE which can perform in a RRC_IDLE state. In some embodiments, the step 2 may be optional. If the UE does not perform the step 2, the step 3 can be still valid. The info sent in step 2 may be sent to the RAN node either during the initial access procedure or after the UE completes the initial access procedure.

In step 3, when the RAN node receives the message in the step 2 or after UE accesses the NW, the RAN node may send a NGAP message 1 to a CN. At least one of the following information can be included in the message: UE info, or a configured IDLE QoE indicator. The configured IDLE QoE indicator can be used to illustrate the UE has been configured QoE which can perform in a RRC_IDLE state.

In step 4, based on the received info in the step3 and a CN stored QoE configuration table, the CN may send the retrieved QoE configurations to the RAN node. At least one of the following info can be included in this message: a QoE reference ID, a service type, an scope, a MCE IP address, a QoE measurement status, a QoE configuration container, NW slicing info, MDT alignment info, a RAN visible configuration, a RRC level ID, a RAN node ID, or a retrieved QoE configuration indicator. The QoE reference ID can be defined by an OAM and can be used to identify a QoE configuration. The service type may indicate a service type of the QoE measurement. The area scope can be a working area of the QoE session. The QoE measurement can only be triggered if the UE is in the area. The area scope may be a cell ID list, a TA list, a PLMN list, or a TAI list. The MCE IP address can be an IP address of the entity receiving the QoE measurement report. The QoE measurement status may indicate the QoE measurement state (e.g. ongoing, not start). The QoE configuration container may include an application layer measurement configuration. The NW slicing info may indicate which NW slice the QoE can measure. The MDT alignment info can be used for the NW to perform the MDT and QoE alignment function. The MDT ID(s) can be added here. The RAN node may determine and may configure the RAN visible QoE configuration to the UE. The RRC level ID can be defined by the RAN node and can be used to distinguish/mark QoE sessions at the RAN side. The UE info can be an AMF UE NGAP ID IE and/or a RAN UE NGAP ID IE. The RAN node ID can be used to identify the last serving NG-RAN node before UE enters a RRC_IDLE state. The retrieved QoE configuration indicator can be used to indicate that the QoE configuration has been configured to the UE. The info contained here can be for configuration retrieve. The NGAP message may be a response message.

In step 5 (optional), the RAN node may forward the received QoE configuration to the UE. For each configured IDLE QoE configuration, at least one of the following information can be included in the NGAP message: a defined QoE configuration or a retrieved QoE configuration indicator. The defined QoE configuration may re-use the defined QoE configuration format. The retrieved QoE configuration indicator can be used to indicate that the QoE configuration has been configured to the UE. The info contained here can be for configuration retrieve.

In some embodiments, the definition of the Short IP Info can be used in several implementation examples in this disclosure. The Short IP Info can be a kind of mark which is used to let a UE know the destination of the generated logged QoE reports. The Short IP Info may be a bit string or a number. The info on mapping relationship between the Short IP Info and the real IP address may have been configured to related NG-RAN nodes by a OAM before the logged QoE configuration. The NG-RAN node may keep the mapping relationship locally.

Table 4 illustrates an example mapping relationship between Short IP Info and real IP address (bit string).

TABLE 4

| Short IP Info | IP address |
|---|---|
| “ . . . 01” | 192.168.0.1 |
| “ . . . 10” | 192.168.0.2 |
| . . . | . . . |

Table 5 illustrates an example mapping relationship between Short IP Info and real IP address (number).

TABLE 5

| Short IP Info | IP address |
|---|---|
| Integer: 1 | 192.168.1.1 |
| Float: 123 | 192.168.1.2 |
| . . . | . . . |

It should be understood that one or more features from the above implementation examples are not exclusive to the specific implementation examples, but can be combined in any manner (e.g., in any priority and/or order, concurrently or otherwise).

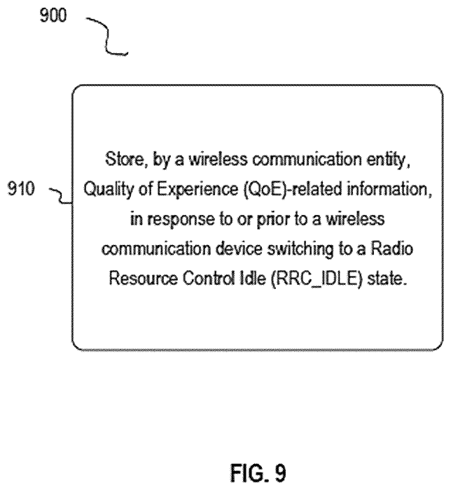

FIG. 9 illustrates a flow diagram of a method 900 for core network (CN) based IDLE Quality of Experience (QoE) configuration retrieve. The method 900 may be implemented using any one or more of the components and devices detailed herein in conjunction with FIGS. 1-2. In overview, the method 900 may be performed by a wireless communication entity, in some embodiments. Additional, fewer, or different operations may be performed in the method 900 depending on the embodiment. At least one aspect of the operations is directed to a system, method, apparatus, or a computer-readable medium.

A wireless communication entity (e.g., a core network (CN)) may store Quality of Experience (QoE)-related information, in response to or prior to a wireless communication device (e.g., a UE) switching to a Radio Resource Control Idle (RRC_IDLE) state. The stored QoE-related information may include only a QoE reference identification of a QoE configuration and an RAN Visible QoE (RVQoE) configuration received from a wireless communication node.

In some embodiments, the wireless communication entity may determine to retrieve the QoE-related information. The wireless communication entity may request the QoE-related information from an Operations, Administration and Maintenance (OAM) entity. The QoE configuration can be associated with the wireless communication device and one or more other wireless communication devices. The QoE-related information may comprise a whole of a QoE configuration. The whole of the QoE configuration may comprise at least one of: a QoE reference identification; a service type; an area scope; an MCE IP address; a QoE configuration container; MDT alignment info; an RAN visible configuration; an RRC level identification; UE information associated with the wireless communication device; or an RAN identification associated with the wireless communication node.

In some embodiments, the wireless communication entity may send the QoE-related information to a wireless communication node, in response to identifying that the wireless communication node or the wireless communication device is to retrieve the QoE-related information. The QoE configuration can be associated with the wireless communication device and one or more other wireless communication devices.

In some embodiments, the QoE-related information may comprise an identification (e.g., a UE ID) of the wireless communication device and a list including a plurality of QoE configurations. The list may comprise a whole of at least one of the QoE configurations which has been configured for the wireless communication device. The QoE-related information may comprise an identification (e.g., a UE ID) of the wireless communication device and a list including a plurality of QoE configurations. The list may comprise at least one of a QoE reference identification of QoE configuration or RAN Visible QoE (RVQoE) configuration which has been configured for the wireless communication device.

In some embodiments, the wireless communication entity may send a first message comprising an indicator for the stored QoE-related information to a wireless communication node. The indicator for the stored QoE-related information may indicate that a CN has stored the QoE configuration. The wireless communication entity may receive a second message from the wireless communication node. The first message and the second message can be each a Next Generation Application Protocol (NGAP) message. The second message may comprise at least one of: a QoE reference identification; a service type; an area scope; an MCE IP address; a QoE configuration container; MDT alignment info; an RAN visible configuration; an RRC level identification; UE information associated with the wireless communication device; or an RAN identification associated with the wireless communication node.

In some embodiments, prior to the wireless communication device switching to the RRC_IDLE state, further comprising: receiving, by the wireless communication entity from a wireless communication node, a message comprising the QoE-related information. The message can be a Next Generation Application Protocol (NGAP) message. The message may further comprise at least one of: a QoE configuration; a QoE reference identification; a service type; an area scope; an MCE IP address; a QoE measurement status; a QoE configuration container; MDT alignment info; an RAN visible configuration; an RRC level identification; NW slicing information; or an RAN identification associated with the wireless communication node.

In some embodiments, the wireless communication entity may receive a first message from a wireless communication node. The first message may comprise at least one of: UE information associated with the wireless communication device or the stored QoE-related information. The wireless communication entity may send a second message acknowledging the first message to the wireless communication node. The first message and the second message can be each a Next Generation Application Protocol (NGAP) message. The QoE-related information can be configured to indicate that a QoE configuration should be released. The UE information can be configured to indicate that the wireless communication device is associated with the to-be released QoE configuration. The UE information may indicate only the wireless communication device. The QoE configuration may indicate a list of QoE reference identifications. In some embodiments, the UE information may indicate a list of UE identifications. The QoE configuration may indicate a list of QoE reference identifications.

In some embodiments, the wireless communication entity may receive a message comprising update to the QoE-related information from a wireless communication node. The message can be a Next Generation Application Protocol (NGAP) message. In response to the wireless communication device accessing a network of the wireless communication entity, further comprising: sending, by the wireless communication entity to a wireless communication node, a message comprising the QoE-related information. The message can be a Next Generation Application Protocol (NGAP) message.

In some embodiments, the message may further comprise at least one of: an indicator for the QoE-related information; a QoE reference identification; a service type; an area scope; an MCE IP address; a QoE measurement status; a QoE configuration container; MDT alignment info; an RAN visible configuration; an RRC level identification; NW slicing information; or an RAN identification associated with the wireless communication node.

In some embodiments, in response to a wireless communication node receiving a first message from the wireless communication device, the first message may comprise at least one of an identification of the wireless communication device or an indicator for the stored QoE-related information. The wireless communication entity may receive a second message comprising the indicator for the stored QoE-related information from the wireless communication node. The wireless communication entity send a third message comprising acknowledging the second message to the wireless communication node. The second message and the third message can be each a Next Generation Application Protocol (NGAP) message. The third message further may comprise at least one of: the indicator for the QoE-related information; a QoE reference identification; a service type; an area scope; an MCE IP address; a QoE measurement status; a QoE configuration container; MDT alignment info; an RAN visible configuration; an RRC level identification; NW slicing information; or an RAN identification associated with the wireless communication node.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method comprising:
storing, by a wireless communication entity, Quality of Experience (QoE)-related information, in response to or prior to a wireless communication device switching to a Radio Resource Control Idle (RRC_IDLE) state.

2. The wireless communication method of claim 1, wherein the stored QoE-related information includes only a QoE reference identification of a QoE configuration and a radio access network (RAN) Visible QoE (RVQoE) configuration received from a wireless communication node.

3. The wireless communication method of claim 2, further comprising:
determining, by the wireless communication entity, to retrieve the QoE-related information; and
requesting, by the wireless communication entity, the QoE-related information from an Operations, Administration and Maintenance (OAM) entity.

4. The wireless communication method of claim 2, wherein the QoE configuration is associated with the wireless communication device and one or more other wireless communication devices.

5. The wireless communication method of claim 1, wherein the QoE-related information comprises a whole of a QoE configuration.

6. The wireless communication method of claim 5, wherein the whole of the QoE configuration comprises at least one of:
a QoE reference identification;
a service type;
an area scope;
a multi-cell/multicast coordination entity (MCE) IP address;
a QoE configuration container;
minimization of drive test (MDT) alignment info;
an RAN visible configuration;
an RRC level identification;
UE information associated with the wireless communication device; or
an RAN identification associated with the wireless communication node.

7. The wireless communication method of claim 5, further comprising:
sending, by the wireless communication entity to a wireless communication node, the QoE-related information, in response to identifying that the wireless communication node or the wireless communication device is to retrieve the QoE-related information.

8. The wireless communication method of claim 5, wherein the QoE configuration is associated with the wireless communication device and one or more other wireless communication devices.

9. The wireless communication method of claim 1, wherein the QoE-related information comprises an identification of the wireless communication device and a list including a plurality of QoE configurations, and wherein the list comprises a whole of at least one of the QoE configurations which has been configured for the wireless communication device.

10. The wireless communication method of claim 1, wherein the QoE-related information comprises an identification of the wireless communication device and a list including a plurality of QoE configurations, and wherein the list comprises at least one of a QoE reference identification of QoE configuration or radio access network (RAN) Visible QoE (RVQoE) configuration which has been configured for the wireless communication device.

11. The wireless communication method of claim 1, further comprising:
sending, by the wireless communication entity to a wireless communication node, a first message comprising an indicator for the stored QoE-related information; and
receiving, by the wireless communication entity from the wireless communication node, a second message;
wherein the first message and the second message are each a Next Generation Application Protocol (NGAP) message.

12. The wireless communication method of claim 11, wherein the second message comprises at least one of:
a QoE reference identification;
a service type;
an area scope;
a multi-cell/multicast coordination entity (MCE) IP address;
a QoE configuration container;
minimization of drive test (MDT) alignment info;
an RAN visible configuration;
an RRC level identification;
UE information associated with the wireless communication device; or
an RAN identification associated with the wireless communication node.

13. The wireless communication method of claim 1, prior to the wireless communication device switching to the RRC_IDLE state, further comprising:
receiving, by the wireless communication entity from a wireless communication node, a message comprising the QoE-related information;
wherein the message is a Next Generation Application Protocol (NGAP) message.

14. The wireless communication method of claim 13, wherein the message further comprises at least one of:
a QoE configuration;
a QoE reference identification;
a service type;
an area scope;
a multi-cell/multicast coordination entity (MCE) IP address;
a QoE measurement status;
a QoE configuration container;
minimization of drive test (MDT) alignment info;
an RAN visible configuration;
an RRC level identification;
network (NW) slicing information; or
an RAN identification associated with the wireless communication node.

15. The wireless communication method of claim 1, further comprising:
receiving, by the wireless communication entity from a wireless communication node, a first message, the first message comprising at least one of: UE information associated with the wireless communication device or the stored QoE-related information; and
sending, by the wireless communication entity to the wireless communication node, a second message acknowledging the first message;
wherein the first message and the second message are each a Next Generation Application Protocol (NGAP) message.

16. The wireless communication method of claim 15, wherein the QoE-related information is configured to indicate that a QoE configuration should be released, and the UE information is configured to indicate that the wireless communication device is associated with the to-be released QoE configuration.

17. The wireless communication method of claim 16, wherein the UE information indicates only the wireless communication device, and the QoE configuration indicates a list of QoE reference identifications.

18. The wireless communication method of claim 16, wherein the UE information indicates a list of UE identifications, and the QoE configuration indicates a list of QoE reference identifications.

19. The wireless communication method of claim 1, further comprising:
receiving, by the wireless communication entity from a wireless communication node, a message comprising update to the QoE-related information;
wherein the message is a Next Generation Application Protocol (NGAP) message.

20. A wireless communication entity, comprising:
at least one processor configured to:
store Quality of Experience (QoE)-related information, in response to or prior to a wireless communication device switching to a Radio Resource Control Idle (RRC_IDLE) state.
